(19) United States
(12) Patent Application Publication
(10) Pub. No.: US 2008/0229948 A1
(43) Pub. Date: Sep. 25, 2008

(54) IMPRINT DEVICE AND METHOD OF MANUFACTURING IMPRINTED STRUCTURE

(76) Inventors: Ryuta Washiya, Ibaraki (JP); Takashi Ando, Ibaraki (JP); Masahiko Ogino, Ibaraki (JP); Hideaki Kataho, Kanagawa (JP); Akihiro Miyauchi, Ibaraki (JP); Kosuke Kuwabara, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,839

(22) Filed: Jan. 25, 2008

(30) Foreign Application Priority Data
Mar. 20, 2007 (JP) 2007-072259

(51) Int. Cl. B41F 1/40

(52) U.S. Cl. 101/324

(57) ABSTRACT

An imprint device transfers a micropattern created on a stamper onto a material to be transferred, by bringing the stamper and the material to be transferred into contact with each other. The imprint device has a flow passage for discharging a fluid to a rear surface of the stamper or the material to be transferred, to thereby bend the stamper or the material to be transferred.

### CROSS REFERENCE TO RELATED APPLICATIONS

This application claims the benefit of Japanese Patent Application No. 2007-072259 filed on Mar. 20, 2007, the disclosure of which is incorporated herein by reference.

### BACKGROUND OF THE INVENTION

1. Field of the Invention

The present invention relates to an imprint device for transferring a microstructure created on a surface of a stamper onto a surface of a material to be transferred, to the stamper, and to a pattern transfer method.

2. Description of the Related Art

Semiconductor integrated circuits have been made extremely smaller in recent years. Formation of patterns of the extremely small circuits, which may be micro-fabricated by photolithography, for example, has required a high degree of accuracy. However, the formation of the circuits with a high accuracy is approaching a limit, as a scale of the micro-fabrication has nearly reached a wavelength of an exposing source for use in the micro-fabrication. To obtain an even higher accuracy, an electron beam writing apparatus, which is a charged particle beam apparatus, has also been used instead of a photolithography apparatus.

However, in forming patterns of extremely small circuits with the electron beam writing apparatus, the more patterns are drawn with the electron beam writing apparatus, the more time it takes for exposure, because the electron beam writing apparatus does not use a one-shot exposure with an exposing source such as an i-ray and an excimer laser. Hence the more integrated the circuits become, the more time it takes for forming patterns, which results in a poor throughput.

To speed up the formation of patterns using an electron beam writing apparatus, an electron beam cell projection lithography technique has been developed, in which electron beams are irradiated en bloc on a plurality of combined masks in various shapes. Such an electron beam writing apparatus for use in the electron beam cell projection lithography technique is necessarily large-sized and high-priced, because a structure of the apparatus becomes more complicated, and a mechanism for controlling each position of the masks with a higher accuracy is required.

In forming patterns of extremely small circuits, imprint lithography has also been known, in which a stamper having a fine pattern complementary to a desired one is stamped onto a surface of a material to be transferred. The material to be transferred may be, for example, a substrate having a resin layer thereon (To simplify descriptions, even after a pattern is transferred on a material to be transferred, the material to be transferred is still referred to as the “material to be transferred” hereinafter). The imprint lithography can transfer a microstructure on a 50 nm scale or less onto a material to be transferred. More specifically, the resin layer (which may also be referred to as a “pattern forming layer”) includes a thin film layer formed on a substrate and a patterned layer composed of protrusions formed on the thin film layer.

The imprint lithography has also been applied to creation of a pattern of recording bits for a large capacity recording medium, and of a pattern of a semiconductor integrated circuit. For example, a mask for fabricating a large capacity recording medium substrate or a semiconductor integrated circuit substrate can be prepared by forming protrusions of a pattern forming layer using the imprint lithography. Then portions of its thin film layer that expose as recesses of the pattern forming layer, and portions of its substrate that are immediately under the portions of the thin film layer, are etched to obtain a desired substrate. Processing accuracy of etching a substrate is influenced by a distribution of thicknesses of a thin film layer in a pass-through direction thereof. To be more specific, a description is made taking as an example, a material to be transferred having a thin film layer with a difference of 50 nm between maximum and minimum thicknesses. If the material to be transferred is etched 50 nm in depth, a substrate under the thin film layer is partly etched in a portion having a smaller thickness, and is not etched in a portion having a larger thickness. Therefore, to obtain a high processing accuracy of etching, a thickness of a thin film layer formed on a substrate has to be uniform, which in turn, a resin layer provided on the substrate has to be uniform.

In one conventional technique for forming a uniform pattern forming layer using imprinting, an imprint device is used in which, when a flat stamper and a flat material to be transferred are brought into contact with each other, fluid is discharged from a rear surface of any one of the stamper or the material to be transferred (see, for example, Japanese Laid-Open Patent Application, Publication No. 2006-326927).

The imprint device can spread out a resin, while flattening waviness on the material to be transferred on a nanometer scale making use of a surface of the stamper. Thus, the imprint device can reduce nonuniformity of the resin, that is, a resultant pattern forming layer.

In another technique for forming a uniform pattern forming layer, an imprint device is used in which a jig is pressed to an end of a stamper, and the stamper which have been mechanically bent in a convex shape is brought into contact with a material to be transferred (see, for example, Japanese Laid-Open Patent Application, Publication No. 2006-303292).

In the imprint device, the stamper is first brought into contact with a center portion of the material to be transferred, and gradually with a peripheral portion thereof. This allows a resin to smoothly flow on the material to be transferred and prevents a bubble from being entrained in the resin (a pattern forming layer).

However, in the imprint device according to the Japanese Laid-Open Patent Application, Publication No. 2006-326927, entire surfaces of both the material to be transferred and the stamper come into contact with each other substantially simultaneously. This may prevent a resin from flowing smoothly or may entrain a bubble in the resin, because a portion of the stamper and/or the material to be transferred is locally loaded, to thereby make a portion of a resultant pattern forming layer nonuniform. This tendency becomes more notable, as a contact area between the material to be transferred and the stamper becomes larger.

In the imprint device according to the Japanese Laid-Open Patent Application, Publication No. 2006-326927, it is difficult to control a pressure distribution on the surface of the material to be transferred. This is because the stamper, of which end is pressed by a jig, is mechanically bent, and it is difficult to flatten the surface of the material to be transferred having waviness on a nanometer scale. This makes a resultant pattern forming layer nonuniform.

The present invention has been made in an attempt to provide an imprint device for obtaining an imprinted structure having a thin uniform pattern forming layer on a material to be transferred, by flattening waviness on a nanometer scale present on a surface of the material to be transferred, and reducing an unobstructed flow of a resin due to a locally loaded pressure on the material to be transferred and/or the stamper; and a method of manufacturing an imprinted structure.

### SUMMARY OF THE INVENTION

According to an aspect of the present invention, an imprint device is provided in which a stamper having a surface with a micropattern created thereon is brought into contact with a material to be transferred, and the micropattern on the stamper is transferred onto a surface of the material to be transferred. The imprint device has a fluid discharge mechanism for discharging a fluid from a rear surface of the stamper or the material to be transferred, to bend the stamper or the material to be transferred. The rear surface of the stamper used herein means a surface opposing to the surface on which a micropattern is created. The rear surface of the material to be transferred used herein means a surface opposing to the surface which comes into contact with the stamper.

According to another aspect of the present invention, a method of manufacturing an imprinted structure including: a contact step in which a stamper having a surface with a micropattern created thereon is brought into contact with a material to be transferred; and a transfer step in which the micropattern on the stamper is transferred onto a surface of the material to be transferred. The method of manufacturing an imprinted structure further includes: a discharge step of discharging a fluid from a rear surface of the stamper or the material to be transferred; and a bending step of bending the stamper or the material to be transferred to which the fluid was discharged. Both the discharge step and the bending step are provided at least either prior to the contact step or subsequent to the transfer step.

Other features and advantages of the present invention will become more apparent from the following detailed description of the invention, when taken in conjunction with the accompanying exemplary drawings.

### BRIEF DESCRIPTION OF THE DRAWINGS

FIG. 1A is a schematic block diagram showing an imprint device according to an embodiment of the present invention. FIG. 1B is a schematic view of up and down mechanisms when viewed from below a stage. FIG. 1C is a schematic view of an arrangement of stamper holding jigs and spacers when viewed from above the stamper.

FIG. 2A to FIG. 2D are plan views each showing a transparent plate constituting a plate according to the embodiment.

FIG. 3A to FIG. 3E are schematic views for explaining steps of the method of manufacturing an imprinted structure according to the embodiment.

FIG. 4 is an electron microscope image showing a surface of an imprinted structure created in a first example.

FIG. 5A is a schematic block diagram showing an imprint device used in a second example according to another embodiment. FIG. 5B is a plan view showing a stage. FIG. 5C is a plan view showing a plate.

FIG. 6A is a schematic block diagram showing an imprint device used in a third example according to still another embodiment. FIG. 6B is a plan view showing a plate.

FIG. 7A to FIG. 7D are views for explaining steps of a method of manufacturing a discrete track medium, in fifth example.

FIG. 8A to FIG. 8E are views for explaining steps of a method of manufacturing a discrete track medium, in a sixth example.

FIG. 9A to FIG. 9E are views for explaining steps of a method of manufacturing a disk substrate for a discrete track medium, in a seventh example.

FIG. 10A to FIG. 10E are views for explaining steps of a method of manufacturing a disk substrate for a discrete track medium, in an eighth example.

FIG. 11 is a schematic block view showing an optical circuit as a fundamental component of the optical device, in a ninth example.

FIG. 12 is a schematic view showing a configuration of waveguides of the optical circuit in the ninth example.

FIG. 13A to FIG. 13L are views for explaining steps of a method of manufacturing a multilayer wiring substrate in a tenth example.

### DETAILED DESCRIPTION OF THE EXEMPLARY EMBODIMENT

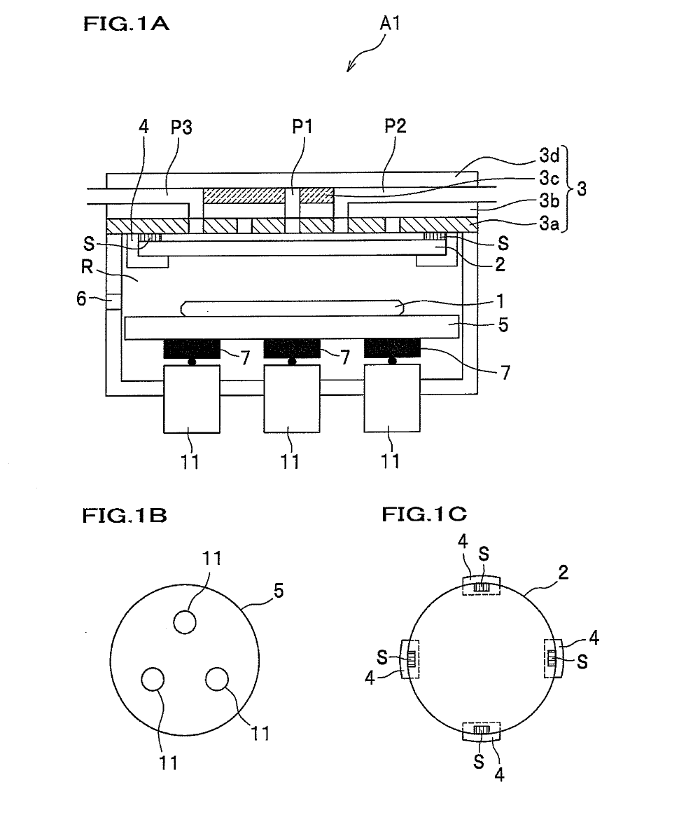

With reference to related drawings, an embodiment of the present invention is described below in detail. It is to be noted that a description below is made assuming that upward and downward directions are based on those in FIG. 1A.

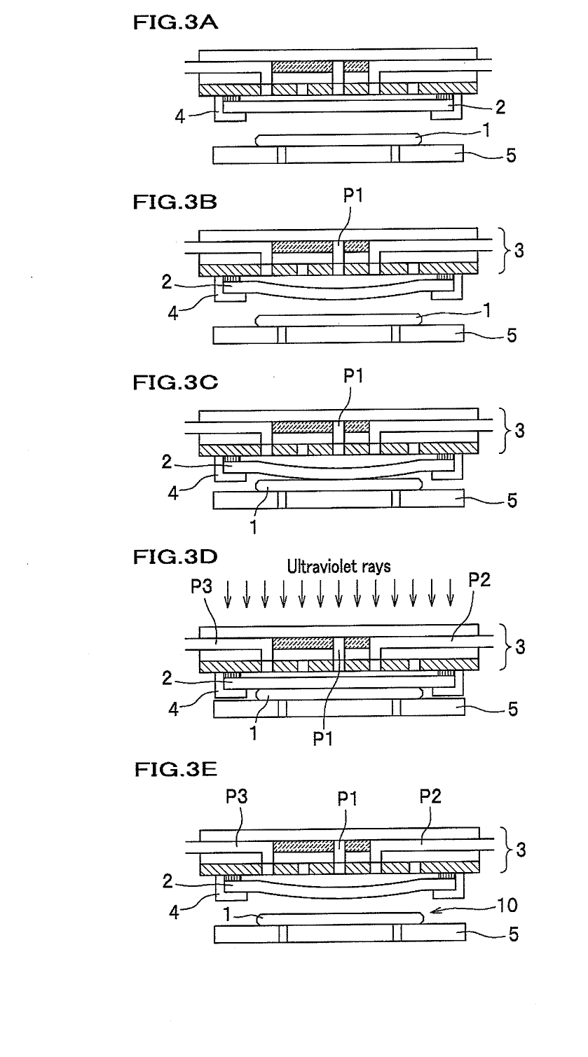

As shown in FIG. 1, an imprint device Al is a device for manufacturing an imprinted structure (see FIG. 3E), which is to be described later, by transferring a micropattern created on a stamper 2 onto a surface of a material to be transferred 1.

The imprint device A1 holds the material to be transferred 1 on a stage 5. The stage 5 moves up and down by up and down mechanisms 11. The stamper 2 is disposed above and opposing to the material to be transferred 1. The plate 3 holds the stamper 2 and has a flow passage P1, a flow passage P2, and a flow passage P3 for discharging a fluid to the stamper, to thereby bend the stamper 2. The flow passages P1,P2,P3 may be also collectively referred to as a fluid discharge mechanism.

The material to be transferred 1 and the stamper 2 face each other surrounded by a decompression chamber R. The decompression chamber R can have a reduced pressure therein using an air exhaust unit such as a vacuum pump not shown and connected to an exhaust port 6. A fluid is discharged to a rear surface of the stamper 2 through at least any one of the flow passages P1,P2,P3. Note that the surface of the stamper 2, which is on an opposite side to the rear surface, has a micropattern to be described later, and that the surface of the material to be transferred 1 is to be in contact with the surface of the stamper 2.

The stage 5 for holding the material to be transferred 1 is disk-shaped and is supported by three up and down mechanisms 11, as shown in FIG. 1A and FIG. 1B.

Each of the up and down mechanisms 11 can freely move up and down by respective motors not shown. As shown in FIG. 1A, the up and down mechanisms 11 have respective load cells 7 thereon for detecting a contact between the material to be transferred 1 and the stamper 2 and a load applied to the material to be transferred 1. The load cells 7 may be also collectively referred to as a detection mechanism. The load detected by the load cells 7 is transmitted to a control mechanism not shown, and fed back for adjusting respective vertical positions of the up and down mechanisms 11. This makes it possible to adjust a contact angle or a peel angle between the stamper 2 and the material to be transferred 1.

As shown in FIG. 1A and FIG. 1C, the stamper 2 is held at its four peripheral portions by the stamper holding jigs 4 onto the plate 3 (a transparent plate 3a). Four spacers S are disposed between the stamper 2 held with the stamper holding jigs 4 and the plate 3 (transparent plate 3a). More specifically, the spacers S are provided at four portions on a periphery of the stamper corresponding to positions of the stamper holding jigs 4. The spacers S are made of thin glass or metal pieces.

The spacers S interposed between the rear surfaces of the stamper 2 and the plate 3 (transparent plate 3a) form a clearance which allows the fluid to flow. A height of the clearance is suitably set such that a pressure of the fluid is enough to bend the stamper 2 and flatten waviness on the surface of the material to be transferred 1. The height may be 0.5 μm or 1 mm. The fluid flows from the plate 3 (transparent plate 3a) through the flow passages P1,P2,P3, the clearance, and the decompression chamber R, and is finally exhausted from an exhaust port 6. As described above, the air exhaust unit such as a vacuum pump not shown and connected to the exhaust port 6 can control a volume of air exhaust, to thereby adjust a degree of the reduced pressure in the decompression chamber R. Note that, if the spacers S cover a whole periphery of the stamper 2, the fluid is confined in the clearance on the rear surface of the stamper 2. This is inconvenient in adjusting a degree of bending the stamper 2. The fluid used herein may be air, nitrogen gas, or any other gas. The fluid preferably does not prevent a light curable resin to be described later from curing.

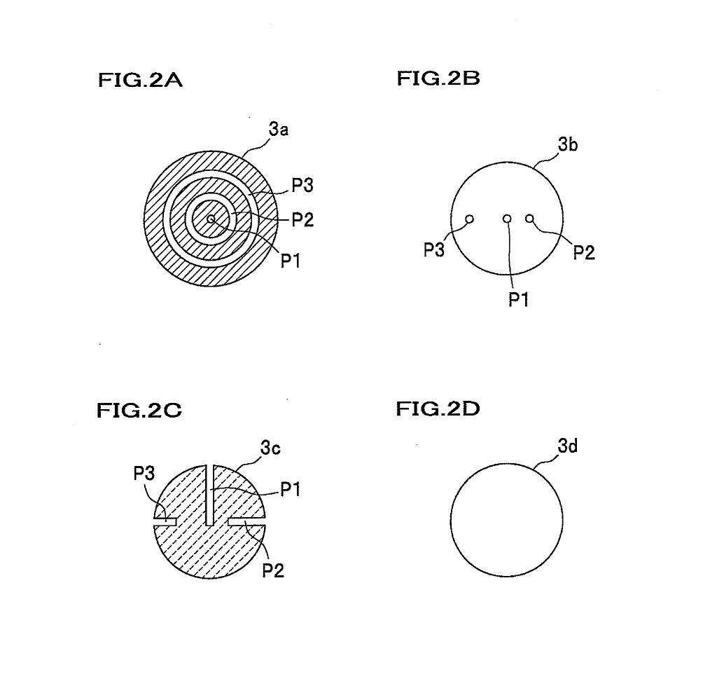

The plate 3 is made of an optical transparent material so as to cure a light curable resin applied to the material to be transferred 1. The plate 3 in the embodiment is made of a disk-shaped transparent material through which ultraviolet rays can pass. The plate 3 includes four transparent plates 3a,3b,3c,3d. FIG. 2A to FIG. 2D are their plan views.

The transparent plate 3a is disposed undermost of the plate 3 and facing to the rear surface of the stamper 2, as shown in FIG. 1A. A hole passing through a center of the transparent plate 3a forms a portion of the flow passage P1, as shown in FIG. 2A. Centering on the flow passage P1, portions of the flow passage 2 and the flow passage 3 are concentrically formed in the transparent plate 3a.

The transparent plate 3b is disposed second undermost of the plate 3, as shown in FIG. 1A. Another portions of the flow passages P1,P2,P3, pass through the transparent plate 3b.

The transparent plate 3c is disposed third undermost of the plate 3, as shown in FIG. 1A. The other portions of the flow passages P1,P2,P3, in the transparent plate 3c are formed of grooves. Respective one ends of the flow passages P1,P2,P3, in the transparent plate 3c are connected to the portions in transparent plate 3b. Respective other ends thereof are each extended to an outer edge of the transparent plate 3c.

The transparent plate 3d is disposed fourth undermost of the plate 3, as shown in FIG. 1A. The transparent plate 3d does not have any portions of the flow passages P1,P2,P3, as shown in FIG. 2D.

As shown in FIG. 1A, in the plate 3 constituted by the transparent plates 3a,3b,3c,3d, the fluid is discharged from the flow passages P1,P2,P3 in the transparent plate 3a after the fluid is supplied to the flow passages P1, P2, P3 at the outer edge of the transparent plate 3c. The fluid is supplied to the flow passages P1,P2,P3 at the outer edge of the transparent plate 3c using a pressure regulation mechanism not shown. The pressure regulation mechanism individually regulates flow rates (discharge pressures) of the fluid discharged from the flow passages P1,P2,P3 in the transparent plate 3a.

Next is described a method of manufacturing an imprinted structure using the imprint device A1 in the embodiment with reference to FIG. 3A to FIG. 3E, which are schematic views for explaining steps of the method of manufacturing an imprinted structure.

Prior to conducting the steps of the method, the stamper 2 and the material to be transferred 1 (see FIG. 1A) as follows are prepared.

The stamper 2 has a micropattern which is to be transferred onto the material to be transferred 1. The micropattern composed of projections and recesses are created on a surface of the stamper 2 using, for example, photolithography, focused ion beam lithography, electron beam writing, and plating, one of which may be selected according to a processing accuracy required for the micropattern to be created.

The stamper 2 used in the embodiment is selected from a material having a light optical transparency, because irradiation of electromagnetic ray such as ultraviolet rays has to reach and cure a photo curable resin applied to the material to be transferred 1 across the stamper 2. However, if a thermosetting resin or a thermoplastic resin is used, instead of the photo curable resin, the stamper 2 may be made of a material not having a light optical transparency.

The stamper 2 may be made of a flexible material according to a thickness thereof so as to be bent when a fluid is discharged to the rear surface thereof. The stamper 2 is thus made of silicon, glass, nickel, resin, or the like. However, the stamper 2 used in the imprint device A1 in which not the stamper 2 but the material to be transferred 1 is to be bent does not have to be made of a flexible material.

The stamper 2 may have a round, oval or polygonal shape according to how the stamper 2 is pressed to the material to be transferred for closely contacting therewith. The stamper may have a hole at its center. A release agent based on fluorine, silicone, or the like may be applied to the surface of the stamper 2 so as to facilitate separation between a photo curable resin of the material to be transferred 1 and the stamper 2. The stamper 2 may have a shape or a surface area different from that of the material to be transferred 1, as long as the stamper 2 can transfer its micropattern onto a predetermined area of the material to be transferred 1.

The material to be transferred 1 in the embodiment is composed of a substrate with a light curable resin applied thereto. A layer made of the light curable resin is translated into a pattern forming layer, after a micropattern on the stamper 2 is transferred thereto.

The substrate may be made of silicon, glass, aluminum alloy, and resin, for example. The substrate may be multilayered having a metal layer, a resin layer, an oxide film layer, or the like on a surface thereof. If the substrate is used in the imprint device A1 in which the material to be transferred 1 is to be bent, the substrate is made of a flexible material according to a thickness thereof.

As the photo curable resin, a known resin material with a photosensitive material added thereto is used. The resin material may include, as a principal component, a cycloolefin polymer, a polymethyl methacrylate, a polystyrene, a polycarbonate, a polyethylene terephthalate (PET), a polylactic acid, a polypropylene, a polyethylene, and a polyvinyl alcohol.

The photo curable resin may be applied to the substrate using a dispense method or a spin-coating method. In the dispense method, the photo curable resin is applied by drops onto the material to be transferred 1. The dropped photo curable resin spreads over a surface of the material to be transferred 1, when the stamper 2 comes into contact with the material to be transferred 1. If the photo curable resin is dropped in plurality of positions on the material to be transferred 1, it is preferable that each distance between centers of the drops is larger than each diameter of the drops. Further, a position to drop the photo curable resin is determined by an estimated spread of the photo curable resin, which corresponds to a size of the micropattern to be formed. A quantity of the photo curable resin is equal to or larger than a quantity of a photo curable resin necessary for forming a pattern forming layer.

In FIG. 3A, the stamper 2 is held with the stamper holding jigs 4, and the material to be transferred 1 is disposed on the stage 5.

In FIG. 3B, a liquid is discharged only from the flow passage P1 in the plate 3. The fluid is discharged to the rear surface of the stamper 2. This step may be referred to as a step of discharging a fluid.

Pressure of the fluid is concentrated on a center part of the stamper 2, to thereby bend the stamper 2 downwardly. This step may be referred to as a step of bending the material to be transferred 1.

The stage 5 is lifted up with the up and down mechanisms 11 (see FIG. 1A). In FIG. 3C, the center part of the stamper 2 is come into contact with a center part of the material to be transferred 1 to apply load of the stamper 2 to the material to be transferred 1. The load cells 7 (see FIG. 1A) detect a change in load, thus detecting a contact of the stamper 2 with the material to be transferred 1. This step may be referred to as a contact step.

The stage 5 is further lifted up, while the pressure of the fluid from the flow passage P1 is gradually reduced. At this time, vertical movements of the up and down mechanisms 11 (see FIG. 1A) are controlled such that loads detected by the three cells 7 (see FIG. 1A) are equal.

The liquid is discharged not only from the flow passage P1 but also from the flow passage P2 and the flow passage 3 (see FIG. 1A), when the detected loads reach a predetermined value. This serves for flattening waviness on the surface of the material to be transferred 1 making use of the surface of the stamper 2. In FIG. 3D, both the surface of the material to be transferred 1 and that of the stamper 2 are flattened and are closely come into contact with each other to transfer the micropattern on the stamper 2 onto the surface of the material to be transferred 1. This step may also be referred to as a transfer step. When the surface of the material to be transferred 1 and that of the stamper 2 are closely brought into contact with each other, vertical movements of the up and down mechanisms 11 (see FIG. 1A) are finely controlled such that loads detected separately by the three cells 7 (see FIG. 1A) are equal. This makes it possible to adjust a contact angle or a peel angle between the stamper 2 and the material to be transferred 1.

In FIG. 3D, the material to be transferred 1 and the stamper 2 are closely into contact with each other, and ultraviolet rays are irradiated thereon from an ultraviolet irradiation device (not shown) disposed above a plate 3 to cure the light curable resin applied on the material to be transferred 1. After the light curable resin is cured, discharge of the fluid from the flow passages P2, P3 is stopped, and the discharge from the flow passage 1 is increased. In FIG. 3E, the stage 5 is lowered down to remove the material to be transferred 1 from the stamper 2. At this time, vertical movements of the up and down mechanisms 11 (see FIG. 1A) are finely controlled such that loads detected separately by the three cells 7 (see FIG. 1A) are equal. As a result, a pattern forming layer made of the cured light curable resin is formed on the surface of the material to be transferred 1, to thereby obtain an imprinted structure.

As described above, the imprint device A1 and the method of manufacturing an imprinted structure in the embodiment are different from a conventional transfer technique in which a jig is pressed to an end of a stamper to mechanically bend the stamper (see, for example, Japanese Laid-Open Patent Application, Publication No. 2006-303292). In the imprint device A1 and the method of manufacturing an imprinted structure, the fluid discharged from the rear surface of the stamper 2 bends the stamper 2 downwardly. The stamper 2 and the material to be transferred 1 are gradually come into contact with each other starting from the center part to the periphery of the stamper 2. When the stamper 2 and the material to be transferred 1 are finally closely into contact with each other, flow rates (discharge pressures) of the fluid discharged from the flow passages P1,P2,P3 are controlled to press the stamper 2 with an equal load against the entire surface of the stamper 2. Further, in the imprint device A1, when the stamper 2 and the material to be transferred 1 are closely come into contact with each other, vertical movements of the up and down mechanisms 11 are finely adjusted such that loads separately detected by a plurality of the load cells 7 are equal. Thus, in the imprint device A1, waviness on the surface of the material to be transferred 1 is flattened making use of the surface of the stamper 2, and a resin flow obstructed by a locally loaded pressure is suitably reduced. Consequently, the imprint device A1 can form a uniform thin pattern forming layer on the surface of the material to be transferred 1.

In the imprint device A1 and the method of manufacturing an imprinted structure, the plate 3 is constituted by four transparent plates 3a,3b,3c,3d, which are stacked one on another in this order, and the flow passages P1,P2,P3 are provided through the transparent plates 3a, 3b, 3c at respective predetermined positions. This prevents an optical transparency of the plate 3 from being blocked by the flow passages P1,P2,P3. In other words, if the flow passages P1,P2,P3 are provided in a single transparent plate, inner walls of the flow passages P1,P2,P3 are misted to be opaque. As a result, a light entering the flow passages P1,P2,P3 is scattered. By contrast, the flow passages P1,P2,P3 are provided through all of the transparent plates 3a,3b,3c of the plate 3. Thus the inner walls of the flow passages P1,P2,P3 will not be misted without reducing the optical transparency thereof.

In the imprint device A1 and the method of manufacturing an imprinted structure, when the stamper 2 and the material to be transferred 1 are come into contact with each other, the surfaces of the stamper 2 and the material to be transferred 1 and exposed to a reduced pressure or a gas atmosphere such as nitrogen in the decompression chamber R. This speeds up curing of the light curable resin. Exposure of the material to be transferred 1 in a reduced pressure prevents a bubble to be formed in the pattern forming layer.

In the imprint device A1 and the method of manufacturing an imprinted structure, when the stamper 2 is separated from the material to be transferred 1 after the transfer step, the stamper 2 is bent downwardly. Thus, the stamper 2 is gradually removed from the material to be transferred 1 starting from the periphery to the center part thereof. This well prevents the micropattern on the material to be transferred 1 from being damaged, which is not obtained in a conventional imprint device in which a flat stamper is separated from a material to be transferred while the stamper maintains its shape (see, for example, Japanese Laid-Open Patent Application, Publication No. 2006-326927).

The present invention has been described with reference to the exemplary embodiment above. However, the present invention is not limited to this, and other various embodiments are possible.

In the embodiment above, a micropattern on the stamper 2 is transferred onto only one surface of the material to be transferred 1. However, micropatterns on a pair of the stampers 2 may be transferred onto both surfaces of the material to be transferred 1. In this case, the material to be transferred 1 is interposed between a pair of the stampers 2, of the plates 3, and of sets of the stamper holding jigs 4.

In the embodiment, the stamper 2 is bent by discharging the fluid thereto. However, the material to be transferred 1 may be bent by discharging the fluid to the rear surface thereof.

In the embodiment, the liquid is discharged from respective discharge ports of the flow passages P1,P2,P3. However, any number of the discharge ports may be provided as long as a degree of bending the stamper 2 is suitably controlled. For example, only one discharge port may be provided at a center portion of the stamper 2.

In the embodiment, the up and down mechanisms 11 for vertically moving the stage 5 are driven by the motors not shown. However, the up and down mechanisms 11 may be attached to the stage 5 via drum cams and the load cells 7. The up and down mechanisms 11 may be driven by pneumatic or hydraulic pressure power.

In the embodiment, the load cells 7 are used for detecting a contact between the stamper 2 and the material to be transferred 1. However, an optical detecting mechanism may be used in which, for example, a laser beam detects a height of the stage 5.

In the embodiment, when the center portions of the material to be transferred 1 and the stamper 2 are come in contact, the flow rate (pressure) of the fluid from the flow passage P1 is gradually reduced. However, the flow rate (pressure) of the fluid from the flow passage P1 may not be changed, and the stage 5 may be further lifted up.

In the embodiment, when the material to be transferred 1 is pressed to the stamper 2, the vertical movements of the up and down mechanisms 11 are adjusted such that loads detected by the three load cells 7 are equal. However, one or two loads detected by the load cells 7 may be smaller than the others. In this case, the material to be transferred 1 is pressed to the stamper 2 at an angle.

In the embodiment, when the material to be transferred 1 is separated from the stamper 2, the vertical movements of the up and down mechanisms 11 are adjusted such that loads detected by the three load cells 7 are equal. However, one or two loads detected by the load cells 7 may be smaller than the others. In this case, the material to be transferred 1 is separated from the stamper 2 at an angle.

In the embodiment, the plate 3 for holding stamper 2 is constituted by the four transparent plates 3a,3b,3c,3d. However, the plate 3 may be constituted by a single transparent plate. In this case, the flow passages P1,P2,P3 may be arranged so as not to prevent ultraviolet rays from reaching the surface of the material to be transferred 1. Further, if the flow passages P1,P2,P3 are formed by cutting, cut surfaces of the flow passages P1,P2,P3 may be ground to keep transparency.

In the embodiment, the spacers S are interposed between the stamper 2 and the plate 3 to form a clearance. However, the spacers S may be thin films, which are formed on a portion of the rear surface of the stamper 2 using sputtering or the like.

In the embodiment, the material to be transferred 1 is prepared by applying a light curable resin onto a substrate. However, the material to be transferred 1 may be prepared by applying a thermosetting resin, a thermoplastic resin, or any other resin onto a substrate, or may be made of only a resin (including a resin sheet). If the material to be transferred 1 containing a thermoplastic resin is used, the material to be transferred 1 is heated to a glass transition temperature of the thermoplastic resin or higher, before the material to be transferred 1 is pressed to the stamper 2. Then, the material to be transferred 1 and the stamper 2 are cooled to cure the thermoplastic resin. In this step, if the material to be transferred 1 containing a thermosetting resin is used, the stamper 2 and the material to be transferred 1 are maintained at or higher than a polymerization temperature of the thermosetting resin to cure the thermosetting resin material. After that, in both cases, the stamper 2 and the material to be transferred 1 are separated from each other, to thereby obtain the material to be transferred 1 with the microstructure of the stamper 2 transferred thereon.

It is to be noted that, if the material to be transferred 1 prepared by applying a resin other than the light curable resin is used, the stamper 2 may not have optical transparency.

The material to be transferred 1 with the microstructure of the stamper 2 transferred thereon, or an imprinted structure, can be applied to an information recording medium such as a magnetic recording medium and an optical recording medium. The material to be transferred 1 can also be applied to a large-scale integrated circuit component; an optical component such as a lens, a polarizing plate, a wavelength filter, a light emitting device, and an integrated optical circuit; and a biodevice for use in an immune assay, a DNA separation, and a cell culture.

### EXAMPLES

Next is described the present invention further in detail with reference to examples.

### Example 1

Example 1 describes a method of manufacturing an imprinted structure using an imprint device A1 shown in FIG. 1A.

The stamper 2 used herein was a quartz substrate having a diameter of 100 mm and a thickness of 0.5 mm. A plurality of concentric grooves were created as a micropattern on a surface of the stamper 2 using a known electron beam direct writing. Each of the grooves had a width of 50 nm, a depth of 80 nm, and a pitch of 100 nm.

The spacers S used herein were created by forming metal thin films each having a thickness of 3 μm on a portion of a rear surface of the stamper 2 using sputtering.

The material to be transferred 1 was prepared by applying an acrylate resin with a photosensitive substance added thereto, onto a glass substrate. The resin was formulated to have a viscosity of 4 mPas. A device used for applying the resin has an application head in which 512 nozzles (256 nozzles×2 rows) were arranged to discharge the resin using a piezo method. A distance between the nozzles was 70 μm in a row direction thereof and a distance between the two rows was 140 μm. Each of the nozzles discharged the resin of about 5 pL. A pitch of the drops applied onto the surface of the material to be transferred 1 was 150 μm in a radial direction and 270 μm in a circumferential direction. The plate 3 was made of quartz.

The stamper 2 was fixed with the stamper holding jigs 4. The material to be transferred 1 set on the stage 5 made of stainless steel. The material to be transferred 1 was adsorption fixed onto the stage 5 via a vacuum adsorption hole (not shown) provided in the stage 5.

Nitrogen gas was discharged only from the flow passage P1 in the plate 3 to bend the stamper 2 downwardly. At this time, a pressure of discharging the nitrogen gas was adjusted such that a difference in height between the center portion and the periphery of the stamper 2 was 2 μm.

The up and down mechanisms 11 lifted up the stage 5. The stage 5 was lifted until one of the three load cells 7 detected a load of 0.01 kN, at which a contact between the stamper 2 and the material to be transferred 1 was confirmed. The stage 5 was further lifted up until all of the three load cells 7 detected loads of 0.25 kN. Nitrogen gas at the discharge pressure of 0.5 MPa was discharged from the flow passages P1,P2,P3. As a result, waviness on a surface of the material to be transferred was flattened by the surface of the stamper 2 to bring the entire surface of the material to be transferred 1 into contact with the stamper 2. The micropattern on the stamper 2 was thus transferred onto the surface of the material to be transferred 1.

Keeping the material to be transferred 1 and the stamper 2 closely into contact with each other, ultraviolet rays were irradiated thereon from an ultraviolet irradiation device (not shown) disposed above the plate 3. The light curable resin was cured. After that, discharge of the nitrogen gas from the flow passages P2,P3 was stopped, and discharge from the flow passage 1 was increased, during which the stage 5 was lowered down. The stamper 2 was separated from the material to be transferred 1, while the stamper 2 was bent downwardly. At this time, vertical movements of the up and down mechanisms 11 were controlled such that loads detected by the three cells 7 were equal.

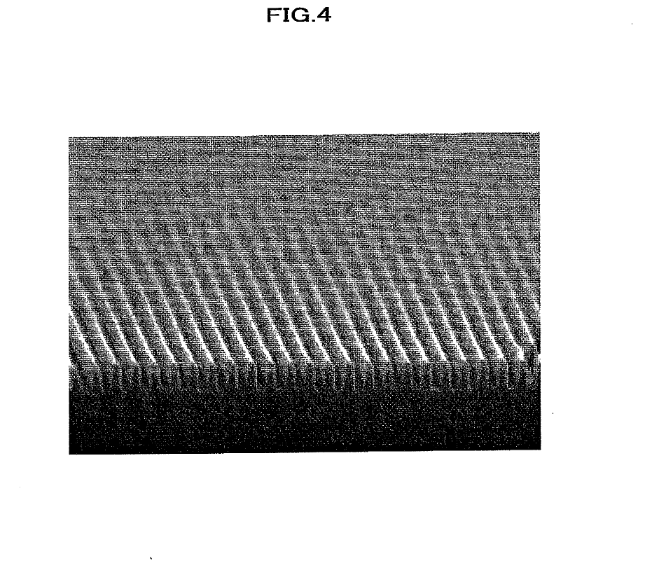

The surface of the material to be transferred 1 (an imprinted structure) was taken out from the imprint device A1 and was observed with a scanning electron microscope (SEM). The SEM observation demonstrated that a resin layer (a pattern forming layer) having a thickness of 20 nm on the surface of the material to be transferred 1 had a grooved pattern corresponding to the micropattern on the stamper 2. Each of grooves of the grooved pattern had a width of 50 nm, a depth of 80 nm, and a pitch of 100 nm. An SEM image of the surface of the imprinted structure manufactured in Example 1 is shown in FIG. 4.

### Example 2

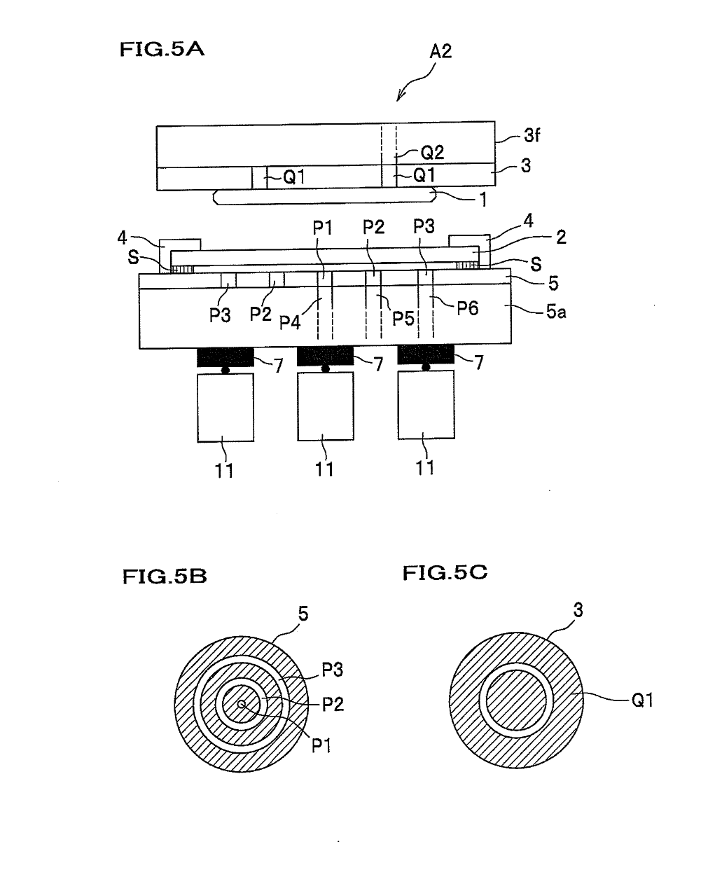

Example 2 describes a method of manufacturing an imprinted structure using an imprint device, which is a variant of the imprint device A1 in Example 1, with reference to FIG. 5A to FIG. 5C. FIG. 5A is a schematic block diagram showing an imprint device according to another embodiment. FIG. 5B is a plan view showing a stage. FIG. 5C is a plan view showing a plate.

As shown in FIG. 5A, an imprint device A2 is different from the imprint device A1 of FIG. 1A in that the stamper 2 is disposed below the material to be transferred 1. The stamper 2 is provided on the stage 5 with the stamper holding jigs 4. The spacers S are interposed between the stamper 2 and the stage 5.

As shown in FIG. 5B, the stage 5 has the flow passages P1,P2,P3, just as the transparent plate 3a shown in FIG. 2A. As shown in FIG. 5B, a support platform 5a for supporting the stage 5 from below has flow passages P4,P5,P6, which are in communication with the flow passages P1,P2,P3, respectively.

The three load cells 7 and the three up and down mechanisms 11 are disposed under the support platform 5a, just as the stage 5 of the imprint device A1 shown in FIG. 1A.

As shown in FIG. 5A and FIG. 5C, the plate 3 has a ring-shaped vacuum adsorption groove Q1. As shown in FIG. 5A, a support platform 3f for supporting the plate 3 from above has a communication passage Q2 for communicating with the vacuum adsorption groove Q1 in the plate 3. The plate 3 and the support platform 3f are made of an optically transparent material. The plate 3 adsorption fixes the material to be transferred 1 via the vacuum adsorption groove Q1.

Next is described a method of manufacturing an imprinted structure using the imprint device A2 described above. Nitrogen gas was discharged only from the flow passage P1 in the stage 5 to bend the stamper 2 upwardly. At this time, a pressure of discharging the nitrogen gas was adjusted such that a difference in height between the center portion and the periphery of the stamper 2 was 2 μm.

The up and down mechanisms 11 lifted up the stage 5. The stage 5 was lifted until one of the three load cells 7 detected a load of 0.01 kN, at which a contact between the stamper 2 and the material to be transferred 1 was confirmed. The stage 5 was further lifted up until all of the three load cells 7 detected loads of 0.25 kN. Nitrogen gas at the discharge pressure of 0.5 MPa was discharged from the flow passages P1,P2,P3. As a result, waviness on a surface of the material to be transferred was flattened by the surface of the stamper 2 to bring the entire surface of the material to be transferred 1 into contact with the stamper 2. The micropattern on the stamper 2 was thus transferred onto the surface of the material to be transferred 1.

Keeping the material to be transferred 1 and the stamper 2 closely into contact with each other, ultraviolet rays were irradiated thereon from an ultraviolet irradiation device (not shown) disposed above the plate 3 and the support platform 3f. The light curable resin was cured. After that, discharge of the nitrogen gas from the flow passages P2,P3 was stopped, and discharge from the flow passage 1 was increased, during which the stage 5 was lowered down. The stamper 2 was separated from the material to be transferred 1, while the stamper 2 was bent upwardly. At this time, vertical movements of the up and down mechanisms 11 were controlled such that loads detected by the three cells 7 were equal.

The material to be transferred 1 (an imprinted structure) was taken out from the imprint device A2. It was observed that a resin layer (a pattern forming layer) having a thickness of 20 nm on the surface of the material to be transferred 1 had a grooved pattern corresponding to the micropattern on the stamper 2. Each of grooves of the grooved pattern had a width of 50 nm, a depth of 80 nm, and a pitch of 100 nm.

### Example 3

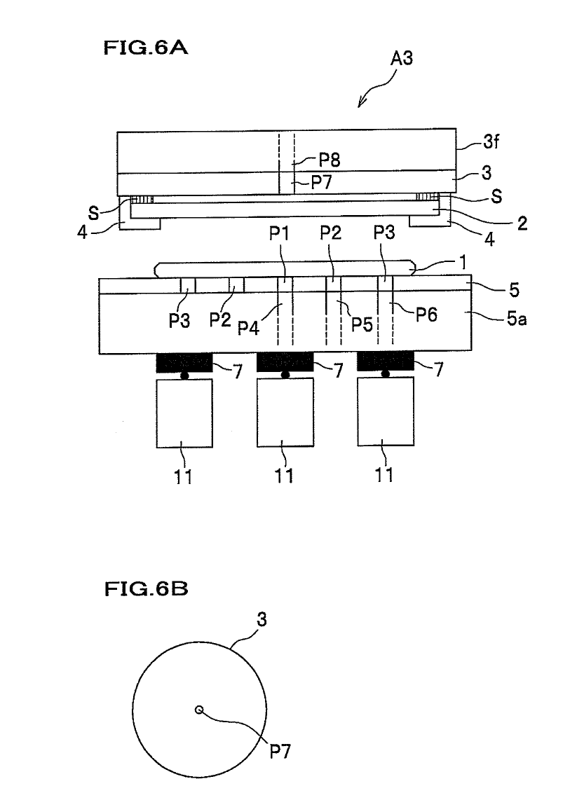

Example 3 describes a method of manufacturing an imprinted structure using another imprint device, which is a variant of the imprint device A1 in Example 1, with reference to FIG. 6A and FIG. 6B. FIG. 6A is a schematic block diagram showing an imprint device according to still another embodiment. FIG. 6B is a plan view showing a plate.

As shown in FIG. 6A, an imprint device A3 is different from the imprint device A2 of FIG. 5A in that the material to be transferred 1 is disposed below the stamper 2. The stamper 2 is attached to the plate 3 with the stamper holding jigs 4. The spacers S are interposed between the stamper 2 and the plate 3. The stamper 2 has optical transparency.

As shown in FIG. 6B, the plate 3 has a flow passage P7 constituted by a hole penetrating through a center of the plate 3. As shown in FIG. 6A, the support platform 3f for supporting the plate 3 from below has a flow passage P8, which is in communication with the flow passages P7.

The stage 5 for setting the material to be transferred 1 thereon and the support platform 5a for supporting the stage 5 from below have flow passages P1,P2,P3,P4,P5,P6, just as the stage 5 of the imprint device A2 shown in FIG. 5A. The three load cells 7 and the three up and down mechanisms 11 are disposed under the support platform 5a.

Next is described a method of manufacturing an imprinted structure using the imprint device A3 described above. Nitrogen gas was discharged from the flow passage P7 in the plate 3 to bend the stamper 2 downwardly. At this time, a pressure of discharging the nitrogen gas was adjusted such that a difference in height between the center portion and the periphery of the stamper 2 was 2 μm.

The up and down mechanisms 11 lifted up the stage 5. The stage 5 was lifted until one of the three load cells 7 detected a load of 0.01 kN, at which a contact between the stamper 2 and the material to be transferred 1 was confirmed. The stage 5 was further lifted up until all of the three load cells 7 detected loads of 0.25 kN. Nitrogen gas at the discharge pressure of 0.5 MPa was discharged from the flow passages P1,P2,P3. As a result, waviness on a surface of the material to be transferred was flattened by the surface of the stamper 2 to bring the entire surface of the material to be transferred 1 into contact with the stamper 2. At this time, the discharge pressure of the nitrogen gas discharged from the flow passage P7 to the rear surface of the stamper 2 was set at 0.1 MPa. The micropattern on the stamper 2 was thus transferred onto the surface of the material to be transferred 1. It is to be noted that, in the imprint device A3, the material to be transferred 1 was pressed toward the stamper 2 by the nitrogen gas discharged from the flow passages P1,P2,P3. This means that the material to be transferred 1 was pressed toward the stamper 2 without contacting with the stage 5.

Keeping the material to be transferred 1 and the stamper 2 closely into contact with each other, ultraviolet rays were irradiated thereon from an ultraviolet irradiation device (not shown) disposed above the plate 3 and the support platform 3f. The light curable resin was cured. After that, discharge of the nitrogen gas from the flow passages P1,P2,P3 in the stage 5 was stopped, and discharge from the flow passage 9 in the plate 3 was set at 0.9 MPa. The up and down mechanisms 11 then lowered down the stage 5. The stamper 2 was separated from the material to be transferred 1, while the stamper 2 was bent downwardly. At this time, vertical movements of the up and down mechanisms 11 were controlled such that loads detected by the three cells 7 were equal.

The material to be transferred 1 was taken out from the imprint device A3. It was observed that a resin layer (a pattern forming layer) having a thickness of 20 nm on the surface of the material to be transferred 1 (an imprinted structure) had a grooved pattern corresponding to the micropattern on the stamper 2. Each of grooves of the grooved pattern had a width of 50 nm, a depth of 80 nm, and a pitch of 100 nm.

### Example 4

Example 4 describes a material with transferred thereon a micropattern for a large capacity magnetic recording medium (a discrete track medium). The material was manufactured by using the imprint device A1 (see FIG. 1A) in Example 1. The material to be transferred 1 used herein was a glass substrate for a magnetic recording medium having a diameter of 65 mm, a thickness of 0.631 mm, and a diameter of a center hole thereof of 20 mm.

As the stamper 2, a quartz substrate having a diameter of 120 mm and a thickness of 0.1 mm was used. A plurality of concentric grooves were created on the quartz substrate using a known direct electron beam writing method. Each of the grooves had a width of 50 nm, a depth of 80 nm, and a pitch of 100 nm. A central axis of the concentric grooves was agreed with that of a center hole of the material to be transferred 1.

A resin was applied by drops onto a surface of a glass disk substrate using an ink jet technique. The resin was an acrylate resin with a photosensitive substance added thereto, and was prepared to have a viscosity of 4 mPas. The resin was applied by an application head, in which 512 nozzles (256 nozzles×2 rows) were arranged to discharge the resin using the piezo method. A distance between the nozzles was 70 μm in a row direction thereof and a distance between the two rows was 140 μm. Each of the nozzles discharged the resin of about 5 pL. The resin was applied by drops each having a diameter in the radial direction of 150 μm and in the circumferential direction of 270 μm.

Using the imprint method same as that in Example 1, the glass substrate, or the material to be transferred 1 on which a pattern of grooves (a microstructure) corresponding to the micropattern 2a formed on a surface of the stamper 2 was transferred was obtained. Each of the grooves had a width of 50 nm, a depth of 80 nm, and a pitch of 100 nm.

### Example 5

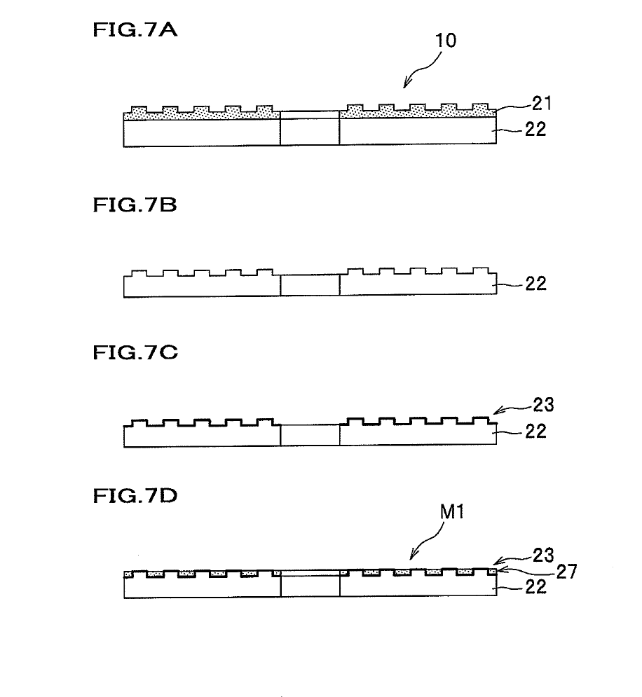

Example 5 describes a method of manufacturing a discrete track medium applying the imprint method of manufacturing an imprinted structure described above with reference to FIG. 7A to FIG. 7D, which are views for explaining steps of the method of manufacturing a discrete track medium.

In FIG. 7A, a glass substrate 22 same as that used in Example 4 and having thereon a pattern formation layer 21 made of a light curable resin on which a micropattern on the stamper 2 had been transferred was prepared.

A surface of the glass substrate 22 was dry-etched with a known dry etching method, utilizing the pattern formation layer 21 as a mask. In FIG. 7B, a microstructure corresponding to the micropattern on the pattern formation layer 21 was etched on the surface of the glass substrate 22. The dry etching was performed with fluorine-based gas. Alternatively, the dry etching may be performed in such a way that a thin layer portion of the pattern formation layer 21 is removed using the oxygen plasma etching, and an exposed portion of the glass substrate 22 is etched with fluorine-based gas.

In FIG. 7C, a magnetic recording medium forming layer 23 was formed on the glass substrate 22 with the microstructure formed thereon, using a known DC magnetron sputtering method (see, for example, Japanese Laid-Open Patent Application, Publication No. 2005-083596). The magnetic recording medium forming layer 23 included a precoat layer, a magnetic domain control layer, a soft magnetic foundation layer, an intermediate layer, a vertical recording layer, and a protective layer. The magnetic domain control layer in this Example further included a nonmagnetic layer and an antiferromagnetic layer.

In FIG. 7D, a nonmagnetic material 27 was applied onto the magnetic recording medium forming layer 23, to thereby make the surface of the glass substrate 22 flat. With the steps described above, a discrete track medium M1 having a surface recording density of about 200 Gbpsi was obtained.

### Example 6

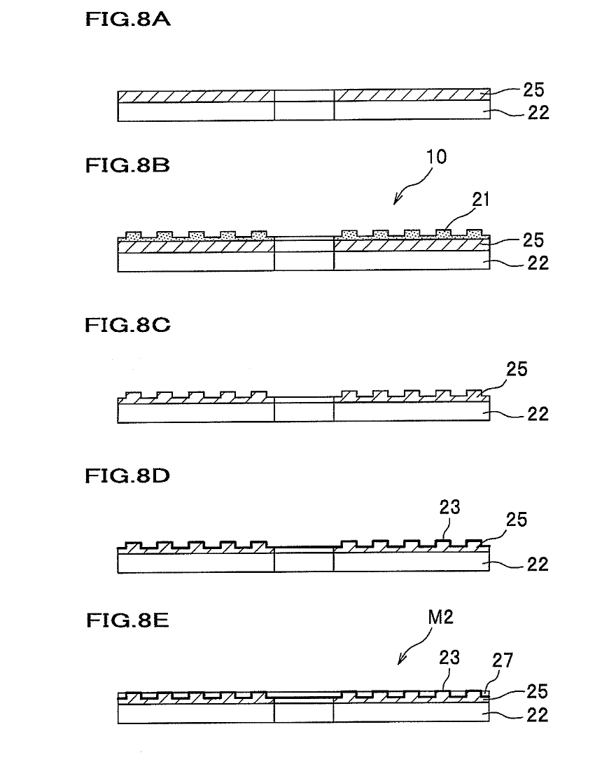

Example 6 describes a method of manufacturing another discrete track medium applying the imprint method of manufacturing an imprinted structure described above with reference to FIG. 8A to FIG. 8E, which are views for explaining steps of the method of manufacturing another discrete track medium.

In FIG. 8A, the glass substrate 22 same as that used in Example 5 and having the soft magnetic foundation layer 25 thereon was used. In FIG. 8B, the pattern formation layer 21 on which a micropattern on the stamper 2 was transferred with a method same as that used in Example 1 was formed on the soft magnetic foundation layer 25, to thereby obtain the imprinted structure.

A surface of the soft magnetic foundation layer 25 was dry-etched with a known dry etching method, utilizing the pattern formation layer 21 as a mask. In FIG. 8C, the dry etching created a microstructure corresponding to the micropattern of the pattern formation layer 21, on the surface of the soft magnetic foundation layer 25. Herein the dry etching was performed with fluorine-based gas.

In FIG. 8D, the magnetic recording medium forming layer 23 was formed on the soft magnetic foundation layer 25 on which the microstructure had been created, using a known DC magnetron sputtering method (see, for example, Japanese Laid-Open Patent Application, Publication No. 2005-083596). The magnetic recording medium forming layer 23 included a precoat layer, a magnetic domain control layer, another soft magnetic foundation layer, an intermediate layer, a vertical recording layer, and a protective layer. The magnetic domain control layer in this Example further included a nonmagnetic layer and an antiferromagnetic layer.

In FIG. 8E, a nonmagnetic material 27 was applied onto the magnetic recording medium forming layer 23, to thereby make a top surface of the soft magnetic foundation layer 25 flat. With the steps described above, a discrete track medium M2 having a surface recording density of about 200 Gbpsi was obtained.

### Example 7

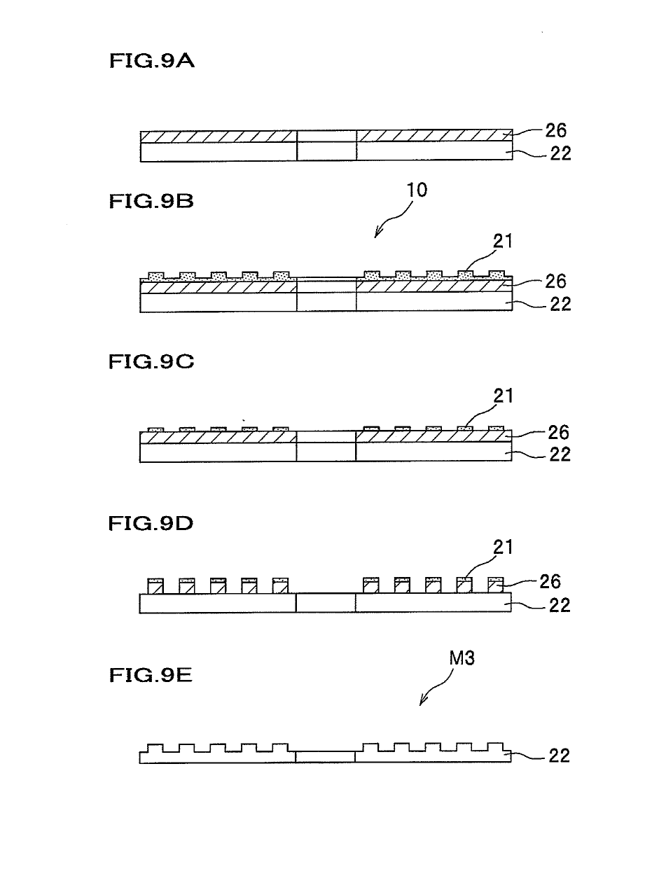

Example 7 describes a method of manufacturing a disk substrate for a discrete track medium applying the imprint method of manufacturing an imprinted structure described above with reference to FIG. 9A to FIG. 9E, which are views for explaining steps of the method of manufacturing a disk substrate for a discrete track medium.

In FIG. 9A, a novolac resin material was applied to a surface of the glass substrate 22 to form a flat layer 26. The flat layer 26 may be formed by the spin coat method or by pressing the novolac resin material to the surface of the glass substrate 22 using a flat plate. In FIG. 9B, the pattern formation layer 21 was formed on the flat layer 26 by applying a resin material containing silicon thereto and using the imprint method of manufacturing an imprinted structure, to thereby obtain the imprinted structure 10.

In FIG. 9C, a thin layer portion of the pattern formation layer 21 was removed with a known dry etching method using fluorine-based gas. In FIG. 9D, the flat layer 26 was removed with the oxygen plasma etching, using a not-yet-removed portion of the pattern formation layer 21 as a mask. In FIG. 9C, the glass substrate 22 was etched using the dry etching method. With the steps described above, a disk substrate M3 used as a discrete track medium having a surface recording density of about 200 Gbpsi was obtained.

### Example 8

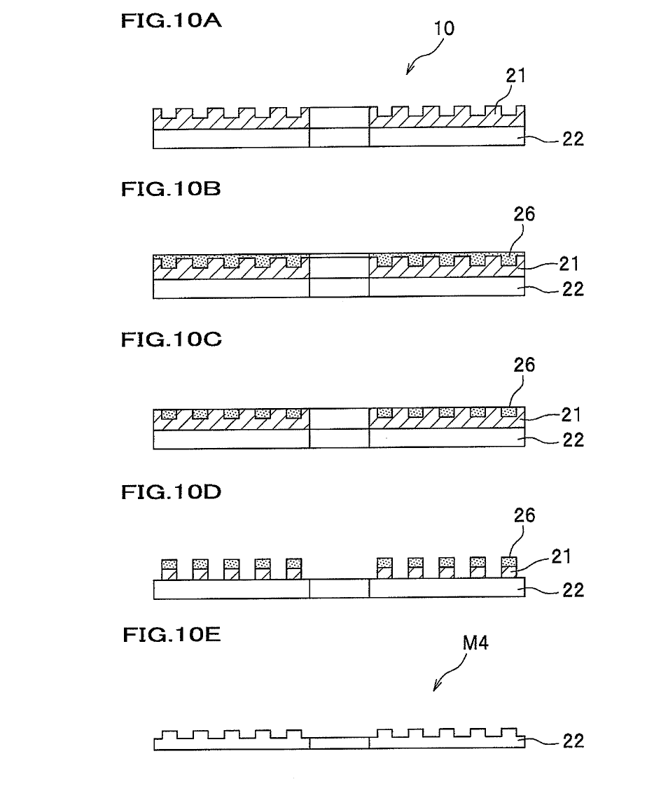

Example 8 describes a method of manufacturing another disk substrate for a discrete track medium applying the imprint method of manufacturing an imprinted structure with reference to FIG. 10A through FIG. 10E, which are views for explaining steps of the method of manufacturing another disk substrate for a discrete track medium.

In FIG. 10A, the pattern formation layer 21 was formed on the glass substrate 22, by applying an acrylate resin material with a photosensitive substance added thereto, to a surface of the glass substrate 22, and by using the imprint method of manufacturing an imprinted structure described above. The imprinted structure was thereby obtained. In this Example, the pattern formation layer 21 was formed to have a microstructure complementary to a desired one. In FIG. 10B, a resin material containing silicon and a photosensitive substance was applied to a surface of the pattern formation layer 21 to form the flat layer 26. The flat layer 21 maybe formed by the spin coat method or by pressing the resin using a flat plate. In FIG. 10C, a surface of the flat layer 26 was etched using fluorine-based gas to remove a thin layer portion of the pattern formation layer 21. In FIG. 10D, the pattern formation layer 21 was removed with the oxygen plasma etching method using a not-yet-removed portion of the flat layer 26 as a mask, thus exposing a portion of the surface of the glass substrate 22. In FIG. 10E, the exposed portion of the glass substrate 22 was etched using fluorine-based gas. With the steps described above, a disk substrate M4 used as a discrete track medium having a surface recording density of about 200 Gbpsi was obtained.

### Example 9

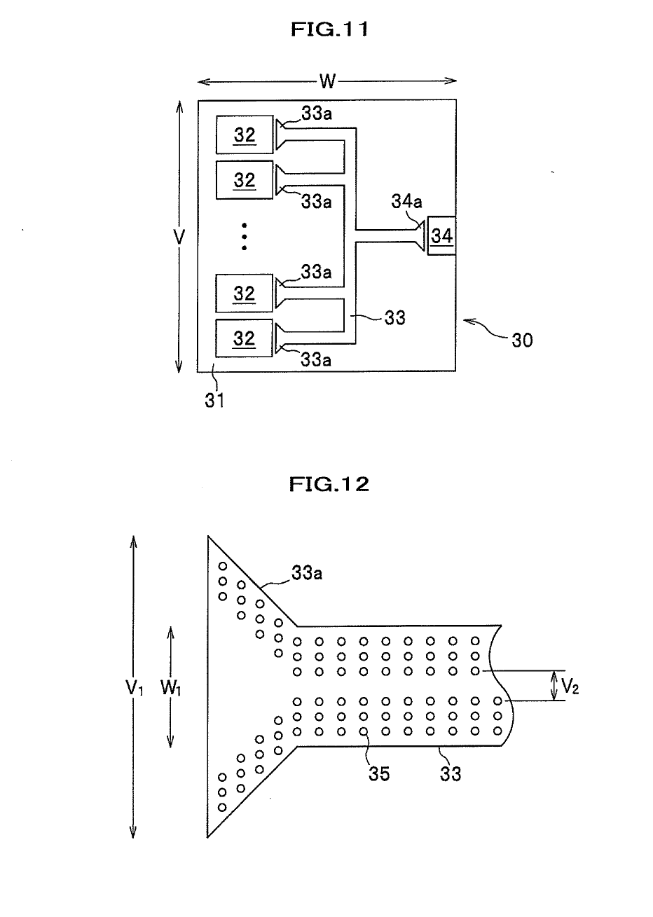

Example 9 describes an optical information processor manufactured by the method of manufacturing an imprinted structure described above with reference to FIG. 11 and FIG. 12. FIG. 11 is a schematic block view showing an optical circuit as a fundamental component of the optical device. FIG. 12 is a schematic view showing a configuration of waveguides of the optical circuit. This Example assumes that the optical information processor is used as an optical device in an optical multiplex communication system in which a traveling direction of an incident light is changed.

In FIG. 11, an optical circuit 30 is created on an aluminum nitride substrate 31 having a length (V) of 30 mm, a width (W) of 5 mm, and a thickness of 1 mm. The optical circuit 30 includes a plurality of oscillation units 32 each including an indium phosphide-based semiconductor laser and a driver circuit; optical waveguides 33,33a; and optical connectors 34,34a. A plurality of the semiconductor lasers had different oscillation wavelengths within a range difference from 2 nm to 50 nm.

In the optical circuit 30, an optical signal inputted from the oscillation unit 32 is transmitted via the waveguides 33,33a is transmitted to the optical connector 34a and then to the optical connector 34. In this case, the optical signal is multiplexed from the waveguides 33a.

As shown in FIG. 12, a plurality of columnar microprotrusions 35 are provided vertically inside the waveguide 33. Each of the waveguides 33a has an opening 20 μm in width (V₁) and a trumpet-shaped axial transverse section so as to tolerate an alignment error that occurs between the oscillation unit 32 and the waveguide 33. The trumpet-like portion of the waveguide 33a had the columnar microprotrusions 35 with a middle row thereof removed in a width direction. This provides a linear region free from a photonic band gap among the microprotrusions 35. The linear region has a width of 1 μm. A distance (pitch) between the adjacent microprotrusions 35 is configured to be 0.5 μm. It is to be noted that FIG. 12 shows only a smaller number of the microprotrusions 35 than the actual ones for simplification.

In this Example, the method of manufacturing an imprinted structure described above is applied to the waveguides 33,33a, and the optical connector 34a. More specifically, the imprint method is applied to an alignment between the substrate 31 and the stamper 2 (see FIG. 1), when predetermined columnar microprotrusions 35 were formed in the waveguides 33,33a and the optical connector 34a. The optical connector 34a is configured to be left-right reverse to the waveguide 33a in FIG. 12. The columnar microprotrusions 35 formed in the optical connector 34a are also configured to be left-right reverse to the columnar microprotrusions 35 in the waveguide 33a in FIG. 12.

An equivalent diameter (a diameter or a length of one side) of each of the columnar microprotrusions 35 may be set within a range between 10 nm and 10 μm, depending on its relationship with a wavelength of a light source used for the semiconductor laser or the like. A height of each columnar microprotrusion 35 may be set within a range between 50 nm and 10 μm. A distance (pitch) between the adjacent columnar microprotrusions 35 may be set at about half a wavelength of a signal used herein.

The optical circuit 30 can multiplex a plurality of rays of signal light having different wavelengths, and output the multiplexed rays. The optical circuit 30 can change a traveling direction of a ray of signal light. This allows a width (W) of the optical circuit 30 to be as small as 5 mm. The optical device manufactured with the imprint method of manufacturing an imprinted structure described above can be therefore reduced in size. Additionally, with the imprint method, the columnar microprotrusions 35 are formed by transferring a micropattern created on the stamper 2 (see FIG. 1), so that a cost of manufacturing the optical circuit 35 can also be reduced. Note that this Example assumes the optical device in which a plurality of incident lights are multiplexed. However, the present invention is applicable to any optical devices for controlling a route of a ray of light.

### Example 10

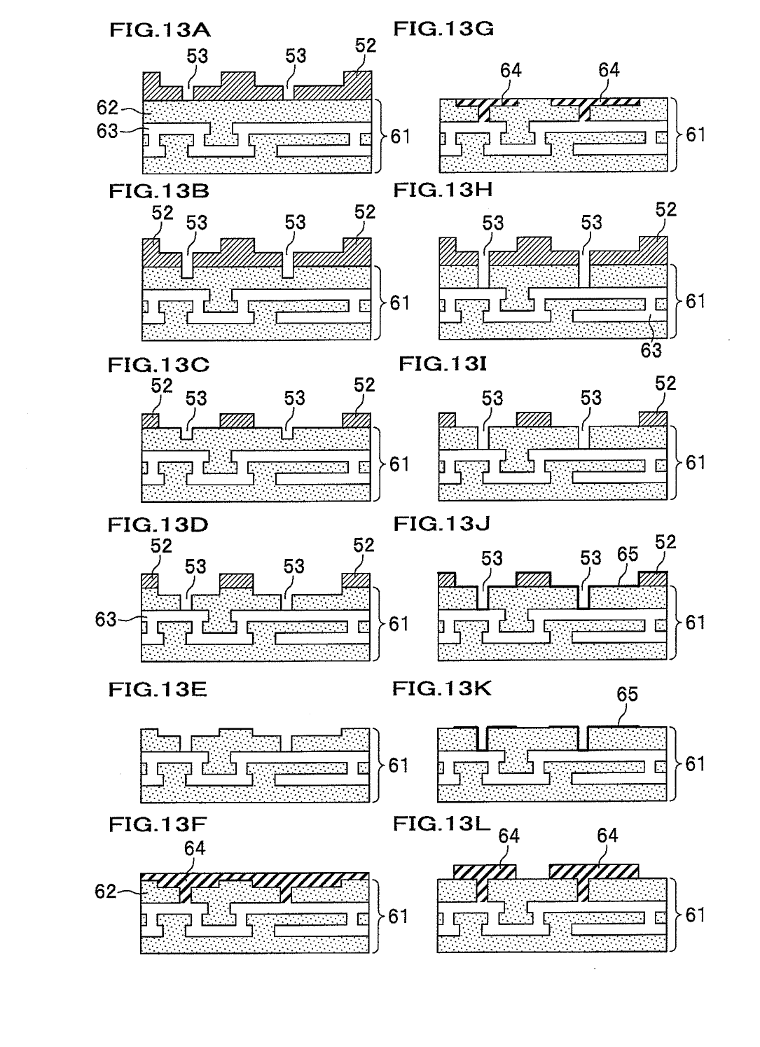

Example 10 describes a method of manufacturing a multilayer wiring substrate using the imprint method of manufacturing an imprinted structure described above with reference to FIG. 13A to FIG. 13L, which are views for explaining steps of the method of manufacturing the multilayer wiring substrate. In FIG. 13A, resists 52 were formed on a surface of a multilayer wiring substrate 61 composed of a silicon dioxide film 62 and a copper wiring 63. The stamper 2 (not shown) and the multilayer wiring substrate 61 were aligned to a desired position. A wiring pattern formed on the stamper 2 was transferred onto a surface of the substrate 61.

In FIG. 13B, exposed portions 53 on the surface of the multilayer wiring substrate 61 were dry-etched with CF₄/H₂ gas to groove down the substrate 61. In FIG. 13C, the resists 52 were resist-etched using RIE, until lower portions of the resists 52 were removed up to the surface of the substrate 61, thus extending the exposed portions 53 surrounding the resists 52 on the substrate 61. In FIG. 13D, the extended exposed portions 53 were further dry-etched until the exposed portions 53 were grooved down to finally reach the copper wiring 63.

In FIG. 13E, the resists 52 were removed to obtain the multilayer wiring substrate 61 having grooves on its surface. A metal film (not shown) was formed on the surface of the multilayer wiring substrate 61, to which was further applied electrolytic plating. In FIG. 13F, the multilayer wiring substrate 61 had a metal plating film 64 formed thereon. The metal plating film 64 was ground until the silicon dioxide film 62 was exposed. As a result, in FIG. 13G, the multilayer wiring substrate 61 having a metal wiring composed of the metal plating film 64 on its surface was obtained.

Next is described another method of manufacturing the multilayer wiring substrate 61 with reference to FIG. 13A and FIG. 13H through FIG. 13L, which are views for explaining steps of another method of manufacturing the multilayer wiring substrate 61.

As shown in FIG. 13A, the multilayer wiring substrate 61 same as that used in the above-mentioned steps was prepared. In FIG. 13H, the multilayer wiring substrate 61 was dry-etched until the exposed portions 53 reached the copper wiring 63. In FIG. 13I, the resists 52 were etched using RIE to remove lower portions thereof. In FIG. 13J, a metal film 65 was formed over the surface of the multilayer wiring substrate 61 using sputtering. In FIG. 13K, the resists 52 were removed using a known liftoff technique, to thereby obtain the multilayer wiring substrate 61 having the metal film 65 partially remaining on the surface of the substrate 61. In FIG. 13L, the remaining metal film 65 was subjected to nonelectrolytic plating. With these steps, the multilayer wiring substrate 61 having a metal wiring composed of the metal film 64 on its surface was obtained. As described above, the present invention is applicable to a manufacture of the multilayer wiring substrate 61 which has a metal wiring with high dimensional precision.

1. An imprint device comprising:
a stamper having a first surface with a micropattern created thereon;
a material to be transferred having a first surface onto which the micropattern on the stamper is transferred; and
a fluid discharging mechanism for discharging a fluid from a second surface opposing to the first surface of the stamper or the material to be transferred to bend the stamper or the material to be transferred.

2. The imprint device according to claim 1, wherein the stamper or the material to be transferred is bent before the first surfaces of the stamper and the material to be transferred are come into contact with each other, and the first surfaces of the stamper and the material to be transferred are flat when the first surfaces of the stamper and the material to be transferred are closely come into contact with each other.

3. The imprint device according to claim 1, further comprising:
a plate provided on the second surface of the stamper or the material to be transferred to be bent for setting the stamper or the material to be transferred; and
a holding mechanism for holding the stamper or the material to be transferred to be bent with a clearance created at least in a portion between the stamper or the material to be transferred to be bent and the plate.

4. The imprint device according to claim 1, further comprising a detection mechanism for detecting a contact between the stamper and the material to be transferred.

5. The imprint device according to claim 4, wherein the detection mechanism detects a contact between the stamper and the material to be transferred by a change in load applied to the stamper or the material to be transferred.

6. A method of manufacturing an imprinted structure device comprising:
a contact step of bringing a stamper having a first surface with a micropattern created thereon into contact with a material to be transferred; and
a transfer step of transferring the micropattern on the stamper onto the material to be transferred having a first surface onto which the micropattern is transferred,
the method further comprising, prior to the contact step:
a discharge step of discharging a fluid from a second surface opposing to the first surface of the stamper or the material to be transferred; and
a bending step of bending the stamper or the material to be transferred with the fluid discharged thereto.

7. A method of manufacturing an imprinted structure device comprising:
a contact step of bringing a stamper having a first surface with a micropattern created thereon into contact with a material to be transferred; and
a transfer step of transferring the micropattern on the stamper onto the material to be transferred having a first surface onto which the micropattern is transferred, the method further comprising, subsequent to the contact step:
a discharge step of discharging a fluid from a second surface opposing to the first surface of the stamper or the material to be transferred; and
a bending step of bending the stamper or the material to be transferred with the fluid discharged thereto.
